(19) United States
(12) Patent Application Publication
(10) Pub. No.: US 2005/0184410 A1
(43) Pub. Date: Aug. 25, 2005

(54) Apparatus and method for drawing an optical fiber

(76) Inventors: Young-Seok Kim, Gumi-si (KR); Sung-Koog Oh, Gumi-si (KR)

Correspondence Address: CHA & REITER, LLC, 210 ROUTE 4 EAST STE 103, PARAMUS, NJ, 07652, US

(21) Appl. No.: 10/835,634

(22) Filed: Apr. 30, 2004

(30) Foreign Application Priority Data
Feb. 20, 2004 (KR) 2004-11310

(51) Int. Cl. B29D 11/00

(52) U.S. Cl. 264/1.27; 264/85; 427/163.2; 385/123

(57) ABSTRACT

A method and apparatus for drawing an optical fiber from an optical fiber preform is disclosed. The method includes the steps of: measuring an outer diameter of the optical fiber as being drawn from the preform and cooling the optical fiber; coating a sheath layer on the peripheral surface of the cooled optical layer; and curing the optical fiber coated with the sheath layer under a nitrogen atmosphere. The quantity of nitrogen charged into the nitrogen atmosphere may be controlled in such a manner that the sheath layer coated optical fiber has a strip force of not less than 1N.

### CLAIM OF PRIORITY

This application claims priority to an application entitled “Apparatus and Method for Drawing Optical Fiber,” filed with the Korean Intellectual Property Office on Feb. 20, 2004 and assigned Serial No. 2004-11310, the contents of which are hereby incorporated by reference.

### BACKGROUND OF THE INVENTION

1. Field of the Invention

The present invention relates to an optical fiber, and in particular to an apparatus and method for fabricating an optical fiber.

2. Description of the Related Art

An optical fiber is fabricated by heating an optical fiber preform having a predetermined composition to a high temperature and then drawing it. Such an optical fiber includes a core for propagating light within the optical fiber and a clad serving to trap light that progresses in the core. A sheath is coated around the clad while the optical is being drawn from an optical fiber preform.

Such an optical fiber preform may be fabricated through various methods such as modified chemical vapor deposition (MCVD), outside vapor deposition (OVD), vapor-phase axial deposition (VAD) for growing a preform on a quartz rod or the like. The optical fiber is then drawn from the fabricated optical fiber preform.

FIG. 1 is a diagram illustrating the construction of a conventional apparatus for drawing an optical fiber. Referring to FIG. 1, the conventional optical fiber drawing apparatus includes a melting furnace 120 for heating an optical fiber preform, a thickness gauge 130 for monitoring the diameter of an optical fiber, a coating applicator 150, a curing device 160, a nitrogen purging device 162, a capstan 170, and a spool 180.

The melting furnace 120 has a cylindrical shape and heats a tip end of a preform 110 introduced into the melting furnace 120. The preform 110 includes a core and a clad. The diameter of the preform is large as compared to that of an optical fiber 111a drawn from the preform 110.

The thickness gauge 130 is located below the melting furnace 120 and monitors the outer diameter of the optical fiber 111a drawn from the preform 110.

The coating applicator 150 allows the optical fiber 111a drawn from the melting furnace 120 to p ass through a coating fluid 151. In this manner, an optical fiber 111b coated with a sheath layer on the peripheral surface thereof. The sheath layer includes a first coating layer formed from a soft material to enhance its adhesion with the optical fiber and its flexibility or bending characteristic. The sheath layer also includes a second coating layer for protecting the optical fiber from external impact and environment. The second coating layer is formed from a material that is easily cured by ultra-violet. A UV-curable resin, thermosetting resin, or the like may be used for the coating fluid 151.

The curing device 160 is located below the coating applicator 150 and incorporates a quartz tube 161. The sheath layer coated on the optical fiber 11b is cured by ultra-violet while the optical fiber is passing through the quartz tube 161.

The nitrogen purging device 162 is positioned on a side of the curing device 160 and charges nitrogen (N₂) gas into the quartz tube of the curing device 160. The sheath layer is then cured under a nitrogen atmosphere.

The capstan 170 pulls the preform 110 with a predetermined force, so that the optical fiber 111a, 111b c an be continuously drawn while maintaining a given diameter. The spool 180 takes a form of cylindrical bobbin for winding thread and the optical fiber 111b is wound on the periphery of the spool 180 while being drawn.

However, the conventional apparatus has a problem in that the area between the coating applicator and the curing device is exposed to the atmosphere and the liquid-phase sheath coated on the optical fiber is contaminated by the atmosphere before the optical fiber is introduced into the curing device. This causes the gel-fraction of the sheath to suffer deterioration.

### SUMMARY OF THE INVENTION

One aspect of the present invention is to provide a method and apparatus for drawing an optical fiber having an improved gel-fraction and strip force of the optical fiber by curing a liquid-phase sheath layer coated on the optical fiber while isolating the sheath layer from the air.

One embodiment of the present invention is directed to a method for drawing an optical fiber from an optical fiber perform. The method includes the steps of: measuring the outer diameter of an optical fiber drawn from an optical fiber preform and cooling the optical fiber; coating a sheath layer on the peripheral surface of the cooled optical fiber, and curing the sheath layer of the optical fiber under a nitrogen atmosphere. The quantity of nitrogen charged into the nitrogen atmosphere may be controlled so that the sheath layer coated optical fiber has a strip force of not less than 1N.

### BRIEF DESCRIPTION OF THE DRAWINGS

The above features and embodiments of the present invention will be more apparent from the following detailed description taken in conjunction with the accompanying drawings, in which:

FIG. 1 is a diagram illustrating the construction of a conventional optical fiber drawing apparatus;

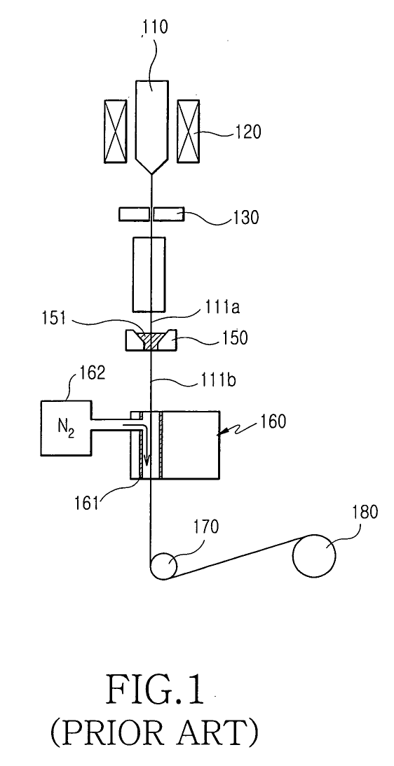

FIG. 2 is a diagram illustrating the construction of an optical fiber drawing apparatus provided with a sealing tube according to one embodiment of the present invention;

FIG. 3 is a diagram illustrating the optical fiber shown in FIG. 2 after a second coating layer is formed; and

FIG. 4 is a graph illustrating variations of strip force and gel-fraction of a drawn optical fiber in connection with charging quantity of nitrogen.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may obscure the subject matter of the present invention unclear.

A method for drawing an optical fiber according to one embodiment of the present invention includes the steps of measuring the outer diameter of an optical fiber and cooling the optical fiber, coating a sheath layer on the peripheral surface of the cooled optical fiber, and curing the sheath layer coated on the optical fiber under a nitrogen atmosphere. The quantity of nitrogen charged into the nitrogen atmosphere may be controlled so that the sheath layer coated optical fiber has a strip force of not less than 1N.

One aspect of this embodiment is that it improves the gel-fraction of a sheath layer as compared to the prior art discussed above and the strip force needed to remove the sheath layer from the optical fiber by curing the sheath coated on the optical fiber under a nitrogen atmosphere having a predetermined pressure or more.

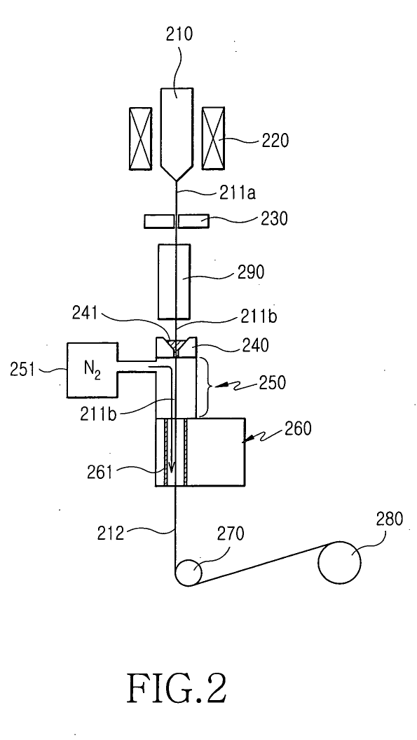

FIG. 2 is a diagram illustrating the construction of an optical fiber drawing apparatus provided with a sealing tube according to an embodiment of the present invention. Referring to FIG. 2, the optical fiber drawing apparatus includes a melting furnace 220 for melting and drawing an optical preform 210, a cooler 290, a thickness gauge 230 for measuring the outer diameter of the optical fiber as being drawn, a coating applicator 240, a curing device 260, a nitrogen device 251, a capstan 270, a spool 280, and a sealing tube 250.

The preform 210 is similar to an optical fiber in that it consists of a core and a clad. However, the diameter of the preform 210 is larger as compared to that of the optical fiber drawn from the preform.

The melting furnace 220 may be in a form of a cylinder and heats a tip end of the preform 210 introduced into the melting furnace 220, thereby melting the preform and drawing an optical fiber. The melting furnace 220 is arranged to allow an inert gas to be provided within the melting furnace 220 to prevent the interior of the melting furnace 220 from being oxidized by heat.

The thickness gauge 230 is positioned below the melting furnace 220 and monitors the outer diameter of the optical fiber 211a as being drawn.

The coating applicator 240 coats a sheath layer on the peripheral surface of the drawn optical fiber 211b by using a coating fluid such as UV-curable resin, thermo setting resin or the like. Typically, in order to enhance flexibility and adhesion with the optical fiber, the sheath layer is coated so that a first coating layer of the sheath layer is coated and then a second coating layer of the sheath layer is coated on the first coating layer. The second coating layer is formed of a material that is easily curable by ultra-violet. As the sheath layer is multi-coated, it can protect the optical fiber 212 from external impact and prevent moisture from permeating into the optical fiber 212. The second coating layer may be formed from a UV-curable polymer selected from an acrylate-based material, a vinyl-based material, etc.

The curing device 260 is positioned below the coating device 240 and may include a quartz tube 261. In this situation, the sheath layer coated on the optical fiber 212 is cured by ultra-violet while the optical fiber is passing through the quartz tube 261.

The sealing tube/enclosure 250 may be in the form of a hollow cylinder and extends from the curing device 260 to the coating device 240. It should be understood that other forms are possible. The sealing tube 250 prevents an uncured sheath layer formed on the optical fiber 211b from being exposed to the air until the sheath layer of the optical fiber 212 is cured. The sealing tube 250 permits the sheath layer of the optical fiber 211b to be easily cured because a nitrogen atmosphere is formed in the interior of the sealing tube 250.

When the uncured liquid-phase sheath layer is exposed to ultra-violet, free radicals of a photoinitator component are produced and form reaction networks such as oligomer, monomer. This allows the sheath layer cure. However, if the uncured liquid-phase sheath layer is exposed to the air, in particular to oxygen, production of free radicals is restrained and hence the sheath layer is not cured. Therefore, in this embodiment, the curing device 260 cures the sheath layer under a nitrogen atmosphere.

The nitrogen device 251 is positioned on a side of the sealing tube 250 and charges nitrogen into the sealing tube 250, so that a nitrogen atmosphere is formed in the sealing tube 250 and the curing device 260. The nitrogen device can be controlled to charge certain quantities of nitrogen into the nitrogen atmosphere.

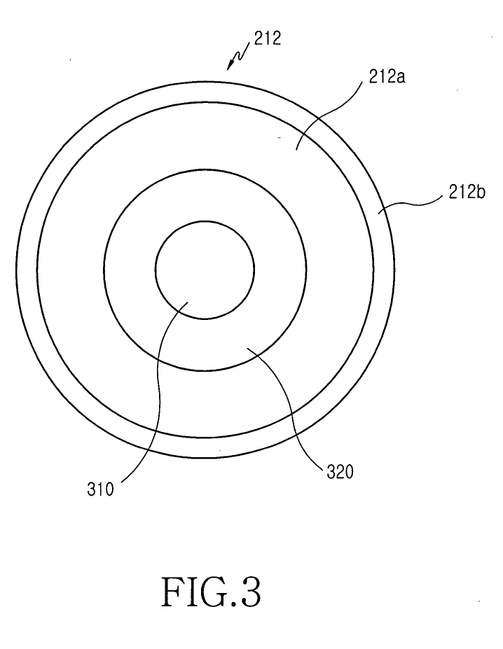

FIG. 3 is a diagram illustrating an optical fiber, on which the sheath layer is formed having two coating layers. Referring to FIG. 3, after passing through the curing device 260, the optical fiber 212 includes a first coating layer 212a coated to wrap the peripheral surface of a clad 320 of the optical fiber 212 and a second coating layer 212b coated on the peripheral surface of the first coating layer 212a.

The first and second coating layers 212a, 212b of the optical fiber 212 passing through the curing device 260 may be formed, for example, by a wet-on-wet process in which the second coating layer is sequentially coated before the first coating layer 212a is cured and then cured, or by a wet-on-dry process in which the second coating layer 212b is coated after the first coating layer 212a is cured.

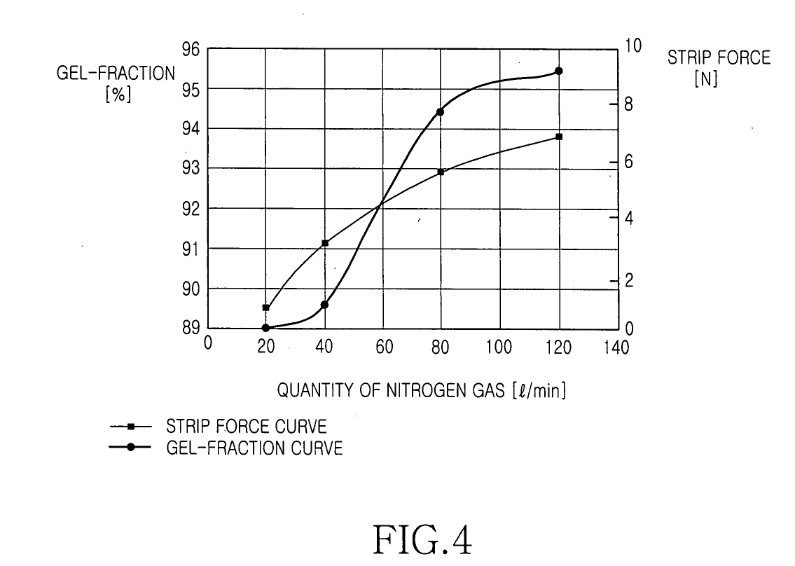

FIG. 4 is a graph illustrating variations of strip force and gel-fraction of a drawn optical fiber in connection with the quantity of nitrogen charged into the nitrogen atmosphere for curing a sheath layer, i.e., first and second coating layers. The x-axis indicates charging quantity of nitrogen per minute, in which the measuring was performed within the range of 20 to 120 l/min. The y₁-axis of the left side in the graph indicates the gel-fraction of a sheath layer coated on the optical fiber, in which the gel-fraction indicates cured fraction in percent (%). The y₂-axis of the right side in the graph indicates how the strip force needed for removing the sheath layer from the optical fiber is increased.

In general, the strip force needed to remove a sheath layer from an optical fiber is in the range of 1N to 9N. The gel-fraction of the sheath layer may be measured with an FT-IR device and the strip force of the sheath layer may be measured with a tensile strength testing machine. If the quantity of nitrogen gas charged when curing the sheath layer of an optical fiber is not less than 40 l/min, the gel-fraction and strip force are increased by 91 to 94% and 1 to 9%, respectively.

The capstan 270 pulls the optical fiber 211a with a predetermined force, so that the optical fiber 211a can be drawn from the preform 210 while maintaining a given diameter. The capstan 270 controls the diameter of the optical fiber by adjusting the force for pulling the optical fiber 211a.

The spool 280 may be in the form of a cylindrical bobbin for winding thread. The optical fiber 212 is wound on the periphery of the spool 280 as the optical fiber is drawn.

As described above, a sealing tube/enclosure isolates an optical fiber. The sealing tube/enclosure is provided between a coating applicator and a curing device. The sheath layer coated on the optical fiber does not come in contact with the air, which enhances the reaction of free radicals and gel-fraction of the sheath layer, as well as increasing the strip force of the sheath layer coated on the optical fiber.

While the invention has been shown and described with reference to certain embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

1. A method comprising the steps of:
drawing an optical fiber perform to form an optical fiber
measuring an outer diameter of the optical fiber;
cooling the optical fiber;
coating a sheath layer on a peripheral surface of the cooled optical layer; and
curing the sheath layer coated on the optical fiber under a nitrogen atmosphere.

2. The method according to claim 1, further comprising the step of controlling a quantity of nitrogen charged into the nitrogen atmosphere so that the sheath layer coated on the optical fiber has a strip force of not less than 1N.

3. The method according to claim 2, wherein in curing step, the sheath layer coated on the optical fiber is cured under a nitrogen atmosphere, in which the quantity of nitrogen charged into the nitrogen atmosphere is not less than 40 l/min.

4. An apparatus for drawing an optical fiber, the apparatus comprising:
a melting furnace for heating an optical fiber perform; means for drawing an optical fiber from the heated preform;
a coating applicator arranged to coat a sheath layer on the peripheral surface of the drawn optical fiber; and
a curing device arranged to cure the sheath layer under a nitrogen atmosphere.

5. The apparatus according to claim 4, further comprising a sealing enclosure extending from the curing device to the coating applicator arranged to prevent the sheath layer from being exposed in air.

6. The apparatus according to claim 5, wherein the sealing enclosure is in the form of a tube.

7. The apparatus according to claim 4, further comprising a nitrogen device that can control a quantity of nitrogen charged into the nitrogen atmosphere.

8. The apparatus according to claim 7, wherein the quantity of nitrogen charged into the coating applicator and the curing device are controlled so that the optical fiber drawn from the preform has a strip force of not less than 1N.

9. The apparatus according to claim 6, wherein the sealing tube takes a form of hollow cylinder that allows the sheath layer coated optical fiber to pass through the sealing tube.

10. The apparatus according to claim 5, further comprising a nitrogen purging device located on a side of the sealing enclosure.

11. The apparatus according to claim 4, wherein the nitrogen atmosphere contains nitrogen of not less than 40 l/min is formed within the coating applicator and the curing device.

12. The apparatus according to claim 4, wherein the sheath layer comprises a second coating layer, the second coating layer being formed from a UV-curable polymer coated on the optical fiber drawn from the preform by the coating applicator.

13. The apparatus according to claim 12, wherein the sheath layer of the optical fiber is cured through a wet-on-wet process.

14. The apparatus according to claim 12, wherein the sheath layer of the optical fiber is cured through a wet-on-dry process.

15. The apparatus according to claim 12, wherein the sheath layer includes an acrylate-based material or a vinyl-based material.

16. A method comprising the steps of:
drawing an optical fiber perform to form an optical fiber
cooling the optical fiber;
coating a sheath layer on a peripheral surface of the cooled optical layer; and
curing the sheath layer coated on the optical fiber in a oxygen-controlled environment.

17. The method according to claim 16, wherein the curing step is performed in a nitrogen atmosphere.

18. The method according to claim 17, further comprising the step of controlling a quantity of nitrogen charged into the nitrogen atmosphere so that the sheath layer coated on the optical fiber has a strip force of not less than 1N.

19. The method according to claim 17, wherein in the curing step, the sheath layer coated on the optical fiber is cured under a nitrogen atmosphere, in which the quantity of nitrogen charged into the nitrogen atmosphere is not less than 40 l/min.
